(19) United States
(12) Patent Application Publication
(10) Pub. No.: US 2026/0353450 A1
(43) Pub. Date: Nov. 5, 2026

(54) GROUP-BASED TRANSMISSION OPPORTUNITY SHARING

(71) Applicant: QUALCOMM Incorporated, San Diego, CA (US)

(72) Inventors: Sanket Sanjay KALAMKAR, San Diego, CA (US); Abhishek Pramod PATIL, San Diego, CA (US); Naveen Kumar KAKANI, Flower Mound, TX (US); George CHERIAN, San Diego, CA (US); Sabita NAHATA, NEWARK, CA (US); Nandkishore PAI, Allen, TX (US); Alfred ASTERJADHI, San Diego, CA (US); Sai Yiu Duncan HO, San Diego, CA (US); Gaurang NAIK, San Diego, CA (US); Sherief HELWA, San Diego, CA (US); Giovanni CHISCI, San Diego, CA (US)

(21) Appl. No.: 19/197,731

(22) Filed: May 2, 2025

(51) Int. Cl. H04W 74/0816; H04W 74/08; H04W 74/0833

(52) U.S. Cl. CPC H04W 74/0816; H04W 74/085; H04W 74/0875

(57) ABSTRACT

This disclosure provides methods, components, devices and systems for group-based transmission opportunity sharing. An access point (AP) may provide a group-based transmission opportunity (TXOP) for a peer-to-peer (P2P) group and the members of the P2P group sharing the group-based TXOP for P2P communications. A station (STA) may be a member of a P2P group, and the STA may output a request for a TXOP. The STA may obtain the TXOP. The TXOP may include an identifier associated with the P2P group, and the TXOP may include a time duration assigned to the P2P group. The STA may output, to the AP, a clear to send message after obtaining the TXOP. The STA may output, to one or more members of the P2P group, an indication of the identifier.

### TECHNICAL FIELD

This disclosure relates generally to wireless communication and, more specifically, to group-based transmission opportunity sharing.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

An innovative aspect of the subject matter described in this disclosure can be implemented in a method at an apparatus. The method may include outputting a first request for a transmission opportunity associated with a peer-to-peer group, obtaining information associated with the transmission opportunity, the information including an identifier of the peer-to-peer group, where the apparatus is a member of the peer-to-peer group, outputting a clear to send message after obtaining the transmission opportunity, and outputting, to one or more members of the peer-to-peer group, an indication of the identifier.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to output a first request for a transmission opportunity associated with a peer-to-peer group, obtain information associated with the transmission opportunity, the information including an identifier of the peer-to-peer group, where the apparatus is a member of the peer-to-peer group, output a clear to send message after obtaining the transmission opportunity, and output, to one or more members of the peer-to-peer group, an indication of the identifier.

Another innovative aspect of the subject matter described in this disclosure can be implemented in an apparatus for wireless communications. The apparatus may include means for outputting a first request for a transmission opportunity associated with a peer-to-peer group, means for obtaining information associated with the transmission opportunity, the information including an identifier of the peer-to-peer group, where the apparatus is a member of the peer-to-peer group, means for outputting a clear to send message after obtaining the transmission opportunity, and means for outputting, to one or more members of the peer-to-peer group, an indication of the identifier.

Another innovative aspect of the subject matter described in this disclosure can be implemented in a non-transitory computer-readable medium storing code for wireless communications. The code may include instructions executable by one or more processors to output a first request for a transmission opportunity associated with a peer-to-peer group, obtain information associated with the transmission opportunity, the information including an identifier of the peer-to-peer group, where the apparatus is a member of the peer-to-peer group, output a clear to send message after obtaining the transmission opportunity, and output, to one or more members of the peer-to-peer group, an indication of the identifier.

In some examples of the method, apparatus, and non-transitory computer-readable medium described herein, the identifier may be a value of an association identifier.

In some examples of the method, apparatus, and non-transitory computer-readable medium described herein, the identifier is a value of a recipient address.

In some examples of the method, apparatus, and non-transitory computer-readable medium described herein, the identifier may be an indication of a transmission occasion sharing mode.

In some examples of the method, apparatus, and non-transitory computer-readable medium described herein, the information associated with the transmission opportunity includes a time duration assigned to the peer-to-peer group.

Some examples of the method, apparatus, and non-transitory computer-readable medium described herein may further include operations, features, means, or instructions for contending, during the time duration and after obtaining the transmission opportunity, for a channel using random backoff.

Some examples of the method, apparatus, and non-transitory computer-readable medium described herein may further include operations, features, means, or instructions for outputting a frame indicating a portion of the time duration assigned to the one or more members of the peer-to-peer group.

Some examples of the method, apparatus, and non-transitory computer-readable medium described herein may further include operations, features, means, or instructions for outputting a frame indicating a return of a transmission opportunity.

Another innovative aspect of the subject matter described in this disclosure can be implemented in a method. The method may include obtaining a first request for a transmission opportunity associated with a peer-to-peer group, outputting information associated with the transmission opportunity, the information including an identifier of the peer-to-peer group, and obtaining a clear to send message after outputting the transmission opportunity.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to obtain a first request for a transmission opportunity associated with a peer-to-peer group, output information associated with the transmission opportunity, the information including an identifier of the peer-to-peer group, and obtain a clear to send message after outputting the transmission opportunity.

Another innovative aspect of the subject matter described in this disclosure can be implemented in an apparatus for wireless communications. The apparatus may include means for obtaining a first request for a transmission opportunity associated with a peer-to-peer group, means for outputting information associated with the transmission opportunity, the information including an identifier of the peer-to-peer group, and means for obtaining a clear to send message after outputting the transmission opportunity.

Another innovative aspect of the subject matter described in this disclosure can be implemented in a non-transitory computer-readable medium storing code for wireless communications. The code may include instructions executable by one or more processors to obtain a first request for a transmission opportunity associated with a peer-to-peer group, output information associated with the transmission opportunity, the information including an identifier of the peer-to-peer group, and obtain a clear to send message after outputting the transmission opportunity.

In some examples of the method, apparatus, and non-transitory computer-readable medium described herein, the identifier may be a value of an association identifier.

In some examples of the method, apparatus, and non-transitory computer-readable medium described herein, the identifier a value of a recipient address.

In some examples of the method, apparatus, and non-transitory computer-readable medium described herein, the identifier may be an indication of a transmission opportunity sharing mode.

In some examples of the method, apparatus, and non-transitory computer-readable medium described herein, the information associated with the transmission opportunity includes a time duration assigned to the peer-to-peer group.

Some examples of the method, apparatus, and non-transitory computer-readable medium described herein may further include operations, features, means, or instructions for obtaining a frame indicating a return of a transmission opportunity.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a frequency diagram depicting an example distributed tone mapping.

FIG. 5 shows a pictorial diagram of another example wireless communication network.

FIG. 6 shows an example of a process flow that supports group-based transmission opportunity sharing.

FIGS. 7 and 8 show block diagrams of devices that support group-based transmission opportunity sharing.

FIG. 9 shows a block diagram of an example wireless communication device that supports group-based transmission opportunity sharing.

FIG. 10 shows a diagram of a system including a device that supports group-based transmission opportunity sharing.

FIG. 11 shows a block diagram of an example wireless communication device that supports group-based transmission opportunity sharing.

FIGS. 12 through 15 show flowcharts illustrating example processes performable by or at an AP that supports group-based transmission opportunity sharing.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a group of wireless communication devices (such as stations (STAs)) may perform peer-to-peer (P2P) group communication. Each member of the P2P group may communicate messages with another member of the group. A wireless access point (AP) may support the P2P group and may allocate resources for the communications between the wireless communication devices within the P2P group. In some examples, the AP may use an access transmit opportunity (TXOP) sharing (TXS) mode 2 to allocate time or a TXOP to one of the associated STAs to perform the P2P communications. For the TXS mode 2, the AP may allocate the TXOP individually to each STA of the P2P group. In TXS mode 2, the P2P communications are restricted to the P2P communications that involve the associated STA that received the TXOP allocation. If there are multiple STAs in the P2P group, the AP allocates multiple TXOPs resulting in overhead and complexity.

Various aspects relate generally aspects relate generally to group-based TXOP sharing. Some aspects more specifically relate to the AP providing a group-based TXOP for a P2P group of STAsa and the STAs sharing the group-based TXOP for P2P communications. In some examples, a STA may be a member of a P2P group, and the STA may output, to an AP, a request for a TXOP. The STA may obtain the TXOP. The TXOP may include an identifier associated with the P2P group, and the TXOP may include a time duration assigned to the P2P group. The STA may output, to the AP, a clear to send message after obtaining the TXOP. The STA may output, to one or more members of the P2P group, an indication of the identifier. In some examples, the identifier may be a value of an association identifier (AID) or a value of a recipient address (RA). The STA may output a frame indicating a portion of the time duration assigned to the one or more members of the P2P group.

Particular aspects of the subject matter described in this disclosure can be implemented to realize one or more of the following potential advantages. In some examples, by obtaining the TXOP including the identifier associated with the P2P group, the described techniques can be used to provide group-based TXOP sharing to improve resource utilization efficiency. In some examples, by outputting the frame indicating a portion of the time duration assigned to the members of the P2P group, the described techniques can be used to provide group-based TXOP sharing to improve resource utilization efficiency.

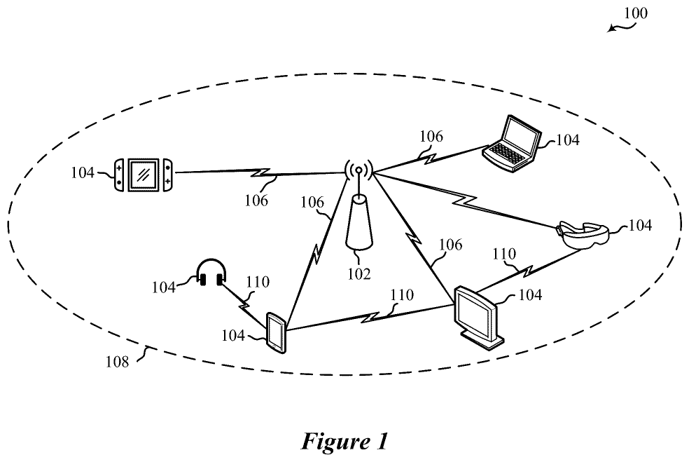

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. A wireless node may refer to a wireless communication device, such as an AP (such as AP 102) or a STA (such as STA 104) that communicates via the wireless communication network 100. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

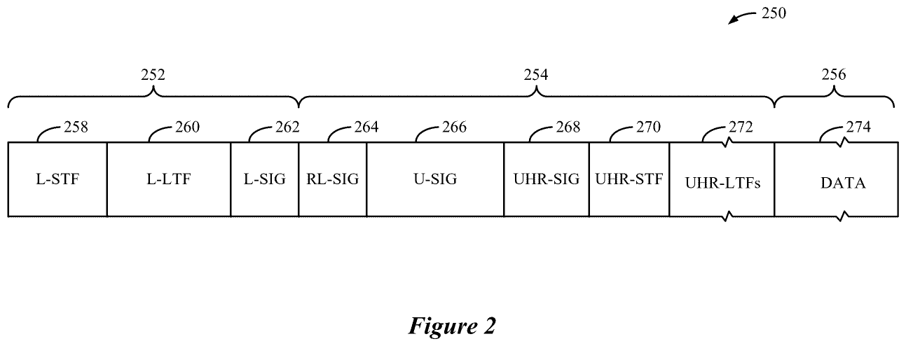

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (such as STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (such as a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (such as a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

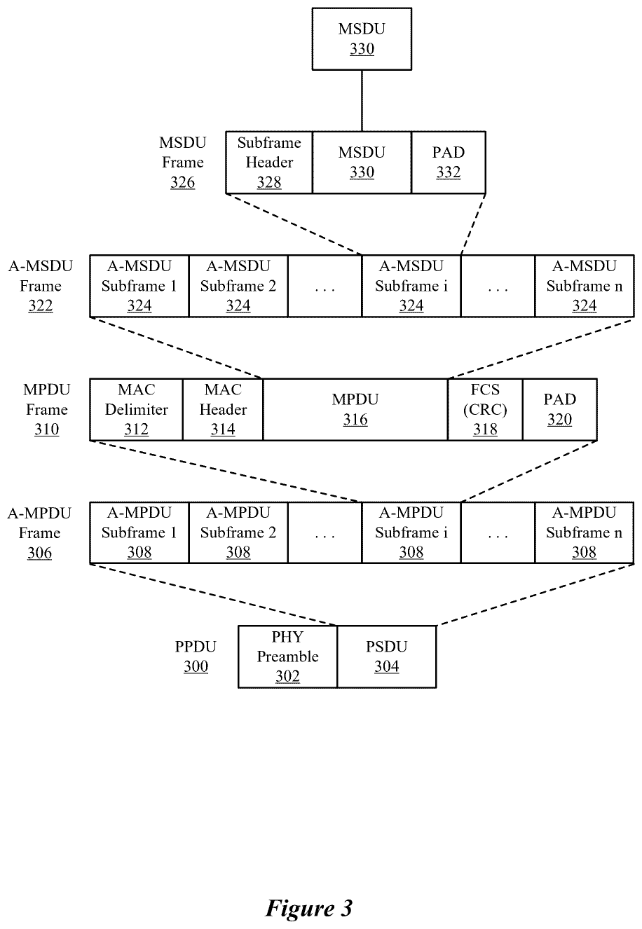

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

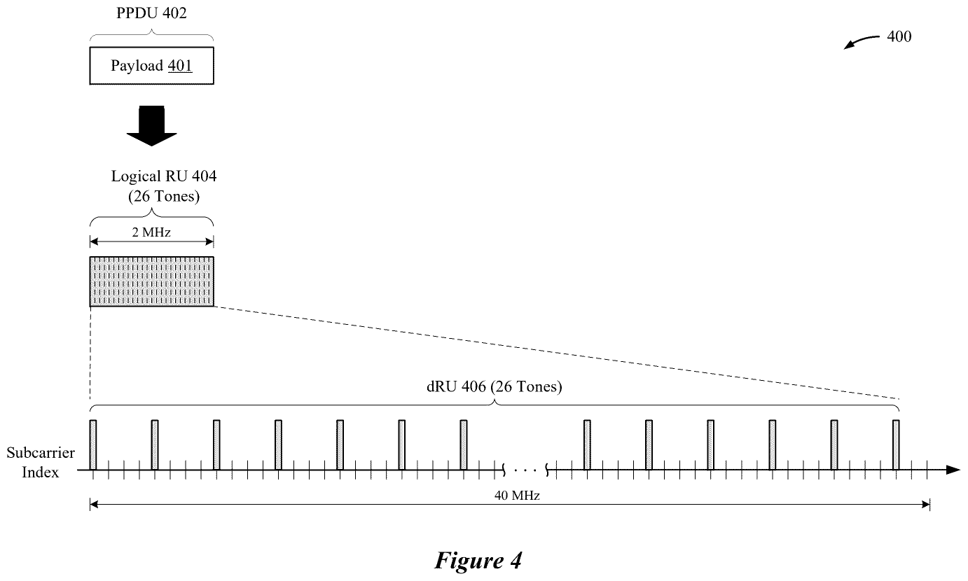

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number of tones (of the logical RU 404) in each 1 MHz subchannel. For example, each of the 26 tones can be mapped to a different 1 MHz subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

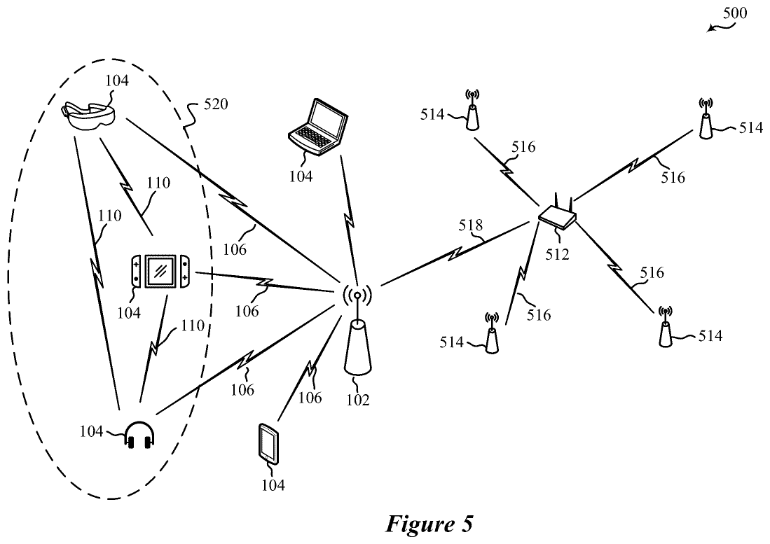

FIG. 5 shows a pictorial diagram of another example wireless communication network 500. According to some aspects, the wireless communication network 500 can be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 102, STAs 104, or both. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (such as cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

As shown in FIG. 5, a group of the STAs 104 may form a network without APs 102 or other equipment other than the group of STAs 104 themselves. One example of such a network is a P2P group 520 (sometimes referred to as a P2P network. In some examples, a P2P group 520 may be implemented within a larger network such as the wireless communication network 100. In such examples, while the STAs 104 may be capable of communicating with each other through the AP 102 using communication links 106, STAs 104 also may communicate directly with each other via direct wireless communication links 110. Additionally, two STAs 104 may communicate via a direct wireless communication link 110 regardless of whether both STAs 104 are associated with and served by the same AP 102. In such a P2P group, one or more of the STAs 104 may assume the role filled by the AP 102 in a BSS. Such a STA 104 may be referred to as a group owner (GO), group coordinator, or group lead. The group coordinator may coordinate resource allocations and transmissions within the P2P group.

In some examples, the group of STAs 104 may form a P2P group 520 to implement a multi-user extended reality (XR) application or other application. For example, the STAs 104 may include goggles, headsets, controllers, rendering devices, or other devices. The STAs or wireless communication devices of the multi-user interactive XR sessions may exhibit similar traffic patterns and sensitivity to latency.

In some examples, a TXOP sharing (TXS) mode 2 may allow the AP 102 to allocate time to an associated STA to perform P2P communications within the P2P group 520. For the TXS mode 2, the P2P communications may be restricted to the P2P communications using the allocated time that the individual STA received from the AP 102. If there are multiple P2P links, the AP may allocate time individually to each link or each STA. In group-based TXOP sharing, multiple links may use (such as share) the allocated time from the AP 102 without requiring the AP 102 to separately allocate time to each P2P link or each STA of the P2P group. The group-based TXOP sharing may improve resource utilization efficiency.

To coordinate transmissions within the P2P group 520, a group-based TXOP sharing mechanism may be used to allow the AP 102 to allocate time to the group of STAs 104 within the P2P group. For the group-based TXOP sharing mechanism, the P2P group 520 may have a group coordinator, such as one of the STAs 104 of the P2P group 520. The group coordinator may be aware of resource requirements of the STAs 104 in the P2P group 520. In some examples, the group coordinator may transmit, to the other STAs within the P2P group, a request for resource allocation information or a request for resources needed information. The group coordinator may receive, from the other STAs within the P2P group, resource allocation information or resources needed information corresponding to the resources needed for upcoming communications by the STAs 104 within the P2P group 520520. Based on the received resource allocation information, the group coordinator may calculate the cumulative resources for upcoming communications within the P2P group 520 including resources needed by the group coordinator.

Based on the determined a resource requirements of the STAs of the P2P group 520, the group coordinator may request a time allocation from the associated AP 102. The requested time allocation may be based on the overall resource allocation need of the P2P group 520. For example, the group coordinator may transmit, to the AP 102, a request for a TXOP allocation or a TXOP. In some examples, each member of the P2P group 520 may individually transmit, to the AP 102, a request for resources. In some examples, any member of the P2P group may transmit, to the AP 102, a request for the TXOP allocation for the P2P group. The AP 102 may determine the TXOP based on the resource requests or TXOP request received from different members of the P2P group. The AP 102 may allocate the time duration to the group coordinator via a trigger frame (e.g., a multi-user request to send TXOP sharing trigger frame (MU-RTS TXS trigger frame)). For example, the group coordinator may receive, from the AP 102, a TXOP allocation (such as the MU-RTS TXS trigger frame) including a time duration assigned to the P2P group 520. The STAs 104 in the P2P group 520 may each share the allocated time for P2P transmissions without each STA 104 obtaining a separate TXOP from the AP 102.

For group-based TXOP sharing, the P2P group may be assigned an identifier or may be addressed using the identifier. The identifier may indicate the members of the P2P group. The identifier used for the P2P group may be determined in a different TXOP than the MU-RTS TXS trigger frame may transmit, such as during the SCS procedure or association. The MU-RTS TXS trigger frame will use the agreed identifier to indicate the P2P group TXOP allocation. In some examples, the AP 102 may configure an identifier for the P2P group. In some examples, the AP 102 may assign an AID for the P 2P group. For example, the AP 102 may assign a 12-bit AID for the P2P group, such as a special AID value of 2025. The STA members of the P 2P group may be aware of the AID assigned to the P2P group. In some examples, the group AID may be negotiated by the group coordinator and may be conveyed to other STAs in the P2P group. For example, the group coordinator may transmit, to the other STAs in the P2P group, the AID assigned to the P2P group.

In some examples, the P2P group may be identified based on a group address. The group coordinator may inform the AP 102 and the members of the P2P group the address to use as the address for the P2P. For example, the group coordinator may transmit, to the AP and the members of the P2P group, the address or identifier associated with the P2P group. In some examples, the AP 102 may configure or may assign a recipient address (RA) for the P2P group.

In some examples, identifier associated with the P2P group may be an indication of a TXS mode, such as TXS mode 3. The MU-RTS TXS trigger frame may allocate time to the P2P group indicating the TXS mode 3. When the MU-RTS TXS trigger frame indicates the TXS Mode 3, the TXS trigger frame may be for time allocation to the P2P group. For the identifier being the indication of the TXS mode 3, the AID may be the AID associated with the group coordinator. If the group coordinator is a coordinator for multiple P2P groups, an additional indication may indicate which P2P group is assigned the TXOP allocation or the MU-RTS TXS Trigger frame. For example, if the group coordinator is a coordinator for two P2P groups, an additional bit indication (0/1) may be used to inform which P2P group gets the TXOP allocation. In some examples, a STA 104 may be members of multiple P2P groups referred by different group AIDs or RAs.

For group-based TXOP sharing, the STAs in the P2P group may be in range of the infra AP. The STAs in the P2P group may be able to receive the MU-RTS TXS trigger frame to determine the allocated time by the AP. To allocate time to the P2P group, the AP may transmit the MU-RTS TXS trigger frame that carries the AID of the P2P group in the AID12 subfield of the user information field of the frame. In another example, the AP may transmit the MU-RTS TXS trigger frame with the RA set to the RA of the P2P group. The time allocated to the P2P group may be specified in the allocation duration subfield of the MU-RTS TXS trigger frame.

In some examples, the group coordinator may transmit, to the AP, a clear to send message as a response to the received MU-RTS TXS trigger frame. For example, if the group coordinator successfully receives the MU-RTS TXS trigger frame, the group coordinator may transmit the clear to send message. In some examples, the clear to send message may occur during the TXOP. The members of the P2P group, not including the group coordinator, may or may not transmit the clear to send message. If the AP does not receive the clear to send response to MU-RTS TXS trigger frame, the AP may transmit a contention-free end (CF-End) frame to terminate the TXS TXOP. The P2P group members may match the transmit address (TA) of the CF-End frame with that of the received MU-RTS TXS trigger frame to cease or come out of the P2P group shared TXOP operation.

In some examples for sharing the TXOP allocation with the P2P group, the AP may transmit the MU-RTS TXS trigger frame to the group coordinator, and the group coordinator may allocate time from the time duration of the TXOP allocation for specific traffic of the P2P group. The group coordinator may be aware of the traffic requirements of group members, such as those defined by a stream classification service (SCS). For example, the group coordinator may receive, from the STAs within the P2P group, resource allocation information with associated SCS, and the group coordinator may transmit, to the AP, the request for the TXOP allocation including the SCS request. Based on an SCS agreement, the AP may transmit the MU-RTS TXS trigger frame with TXOP to serve traffic for particular SCS identifiers (IDs). In this example, the group coordinator may manage the time allocation among members of the P2P group to ensure that traffic for the SCS IDs is served.

In some examples, the MU-RTS TXS trigger frame may include a network allocation vector (NAV) covering the allocated time to the P2P group. After receiving the TXS trigger frame including the configured group AID associated with the P2P group, the STAs in the P2P group may not set an associate in basic service set (IN-BSS) NAV and may be free to contend for the medium within the allocated time (if needed). If the members of the P2P group obtain the CF-END frame, the STAs may cease P2P group operation. In some examples, the MU-RTS TXS trigger frame may set a short NAV covering a short interframe space (SIFS) and the clear to send response after the TXS trigger frame. For allocated time, the corresponding P2P STAs may each set the NAV covering their respective portion of time for their respective transmissions.

After obtaining the TXOP assigned to the P2P group, the members of the P2P group may access the channel during the time duration of the TXOP. In some examples, the members of the P2P group may contend for the channel using random back off (RBO). The RBO may be based on an enhanced distributed channel access (EDCA) mechanism, and the EDCA parameters may pertain to an access category (AC). For example, the access category may include the use of a contention window minimum (CWmin) parameter or a contention window maximum (CWmax) parameter for access category voice (AC_VO) or access category video (AC_VI). In some examples, the AC_VO parameters may be used if the medium remains idle for a sufficient duration. STAs not belonging to the P2P group may jump in and access the channel during the TXOP if RBO parameters for lower ACs are used.

In some examples, the P2P group coordinator may manage the channel access by the members of the P2P group during the time duration of the TXOP allocation. For example, the group coordinator may transmit a frame indicating a portion of the time duration assigned to each member of the P2P group for scheduling access to the medium. In some examples, the scheduling of access to the medium during the time duration may be based on the traffic priority of the member of the P2P group. The group coordinator may leverage knowledge of the resource needs of each member in the P2P group and the associated priorities of the traffic. In some examples, the group coordinator may schedule the channel access in a round-robin manner. After responding with the clear to send messages to the received MU-RTS TXS trigger frame, the group coordinator may transmit a trigger frame to the members of P2P group announcing the schedule to access the medium. In some examples, this scenario of the group coordinator transmitting the trigger frame may be possible if the group coordinator is a mobile AP, and the mobile AP may transmit the trigger frame to solicit uplink data from STAs that are members of the P2P group. In another example, the channel access within the P2P group may be a mix of RBO and traffic priority, where high-priority traffic members use EDCA parameters for AC_VO, while other members use EDCA parameters for AC_VI or lower AC. In another example, the channel access within the P2P group may use a prioritized EDCA (P-EDCA) mechanism of the ultra high reliability deployment.

For sharing the TXOP allocation with the P2P group, the TXOP may be returned to the AP 102. If the transmissions within the P2P group finish before the end of the allocated time duration given by the AP, the TXOP (or a portion of the time duration of the TXOP) may be returned to the AP. The TXOP may be returned by the group coordinator where the group coordinator is an associated STA to the infra AP. The group coordinator may transmit a TXOP return frame to the infra AP indicating the return of the TXOP. The TXOP return indication may be carried in a command and status (CAS) control field with the reverse direction grant or more physical layer protocol data unit (RDG/More PPDU) subfield by setting the field equal to 0. The CAS control field may be carried in a MAC header of a management frame addressed to the infra AP or in a quality of service (QoS) data or QoS null frame that includes a high efficiency (HE) variant high throughput (HT) control field with a CAS control subfield. The AP may transmit an acknowledgment (Ack) frame as a response to the successful reception of the TXOP return frame. Other members of the P2P group may process the TXOP return frame. The TXOP return frame may include the address of the group coordinator in the TA field. After processing the TXOP return frame, the P2P members may relinquish the TXOP. The TXOP return frame may carry additional information, such as more time needed for the P2P group in the future and change in the group coordinator. In some examples, an explicit TXOP return frame may not be transmitted by the P2P group, and the STAs of the P2P group may sense the medium and may check that a TXOP return condition is met. For example, if the STAs of the P2P group sense the medium is idle for a duration threshold, the STAs of the P2P group may assume that the TXOP is relinquished by the P2P group. Similarly, if the AP senses that the medium is idle for the duration threshold, the AP may reclaim the TXOP. In some examples, the AP may include an indication in the MU-RTS TXS trigger frame of the TXOP return if the P2P group finishes transmissions before the allocated time duration ends.

In some examples, the P2P group may receive the time allocation without contending for the medium. Without contending for the medium allows the P2P group to occupy extra time compared to the AP without time allocation. As a result, neighboring devices (both AP and non-AP STAs) may wait longer to access the medium that may lead to unfair channel access. To improve fairness of channel access, the P2P group may use the allocated time given by the infra AP only for the traffic that belongs to an AC that is equal to or higher than the primary AC of the TXOP for the infra AP. In some examples, the time allocated to the P2P group may not exceed the time used by the AP for its in-BSS transmissions. In some examples, the time allocated to the P2P group may not exceed the TXOP limit for a certain AC, such as AC_VI or the primary AC.

In some examples, after transmitting the MU-RTS TXS trigger frame, if the AP senses the medium to be idle for a duration threshold, the AP may reclaim the medium. The duration threshold may be a point coordination function interframe space (PIFS) duration, or a clear to send timeout duration. If multiple P2P groups will be allocated time in the same TXOP, the AP may indicate an estimated time for the next MU-RTS TXS trigger frame in the current MU-RTS TXS trigger frame.

In some examples, the time allocation given by the AP may be used by a member of the P2P group to transmit uplink data to the AP that transmitted the MU-RTS TXS trigger frame. For example, the member of the P2P group that receives a time allocation due to the MU-RTS TXS trigger frame that contains a user info field addressed to the P2P group (such as the group AID or configured AID for the group) may update the CWmin[AC], CWmax[AC], arbitration inter-frame space number (AIFSN)[AC], and multi-user UEDCA timer[AC] state variables to values contained in a dot11MUEDCATable, for the ACs from which at least one QoS data frame was transmitted successfully in a non-trigger-based PPDU to the AP within the time allocated in the Trigger frame.

In some examples, during the time allocated by an AP using an MU-RTS TXS trigger frame, a member of the P2P group addressed by the MU-RTS TXS trigger frame may transmit on subchannels that are not used when sending the clear to send frame in response to the MU-RTS TXS trigger frame. The member of the P2P group addressed by an MU-RTS TXS trigger frame may set a transmission vector (TXVECTOR) parameter, a channel bandwidth (CH_BANDWIDTH), or a channel bandwidth in non-HT (CH_BANDWIDTH_IN_NON_HT) of a transmitted non-TB PPDUs, during the time allocated by the MU-RTS TXS trigger frame, to be the same or narrower than the TXVECTOR parameter or CH_BANDWIDTH_IN_NON_HT of the clear to send frame transmitted in response to the MU-RTS TXS Trigger frame.

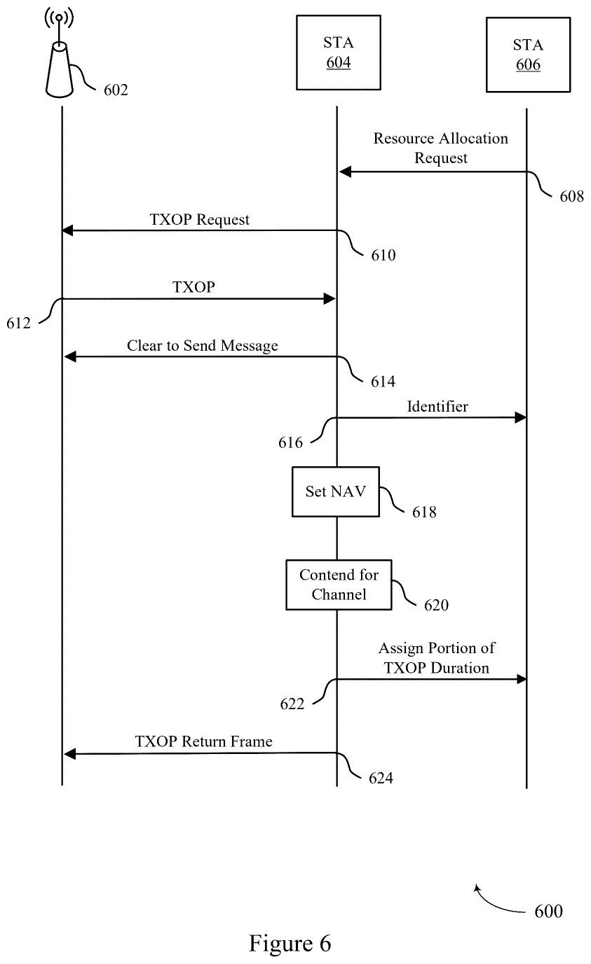

FIG. 6 shows an example of a process flow 600 that supports group-based transmission opportunity sharing. For example, an AP 602, a STA 604, and a STA 606 may be examples of corresponding devices described with reference to FIGS. 1-5, may perform wireless communications in accordance with the process flow 600. In the following description of the process flow 600, the operations between the AP 602, STA 604 and STA 606 may be transmitted in a different order than the example order shown, or the operations performed by the AP 602, STA 604 and STA 606 may be performed in different orders or at different times. Some operations also may be omitted from the process flow 600, and other operations may be added to the process flow 600. In some examples, the STA 604 may include or more transceivers configured to transmit the request, receive the TXOP allocation, and transmit the clear to send message. In some examples, the AP 602 may include or more transceivers configured to receive the request, transmit the TXOP allocation, and receive the clear to send message request. In some examples, the STA 604 may be group coordinator for a P2P group, and the STA 606 may be one of the members of the P2P group.

At 608, the STA 604 may obtain a resource allocation request from the STA 606. The resource allocation request may include a stream classification service.

At 610, the STA 604 may output, to the AP 602, a request for a TXOP for a P2P group.

At 612, the STA 604 may obtain, from the AP 602, a TXOP including an identifier associated with the P2P group. The identifier may be a value of an AID. The identifier may be a value of a RA. The identifier may be an indication of a TXOP sharing mode (such as transmit share mode three). In some examples, the TXOP may be obtained as an MU-RTS TXS Trigger frame that includes the identifier associated with the P2P group. In some examples, the TXOP may be based on the stream classification service of the resource allocation request.

In some examples, the TXOP may include a time duration assigned to the P2P group. The TXOP may include a network allocation vector associated with the duration. The time duration may be less than or equal to a transmission opportunity limit associated with an access category. The time duration may be less than or equal to a duration associated with data transmissions within a basic service set. The duration may be associated with a transmission having an access category that has an associated priority higher than or equal to a primary access category.

At 614, the STA 604 may output, to the AP 602, a clear to send message after obtaining the TXOP. In some examples, the clear to send message is output via a first subchannel.

At 616, the STA 604 may output, to the STA 606, an indication of the identifier.

At 618, the STA 604 may set a network allocation vector associated with at least a portion of the duration.

At 620, the STA 604 may contend for a channel using random backoff during the time duration. The random backoff may be based on one or more enhanced distributed channel access parameters associated with traffic priority. In some examples, the STA 604 may contend for a channel using prioritized enhanced distributed channel access during the time duration. In some examples, the STA 606 may contend for the channel using random backoff or prioritized enhanced distributed channel access during the time duration. In some examples, the STA 604 may output a message on a second subchannel during the time duration, and the message may be different from the clear to send message

At 622, the STA 604 may output, to the STA 606, a frame indicating a portion of the time duration assigned to the one or more members of the peer-to-peer group.

At 624, the STA 604 may output, to the AP 602, output a frame indicating a return of a TXOP. The frame indicating the return of the TXOP may include a second request for a second TXOP.

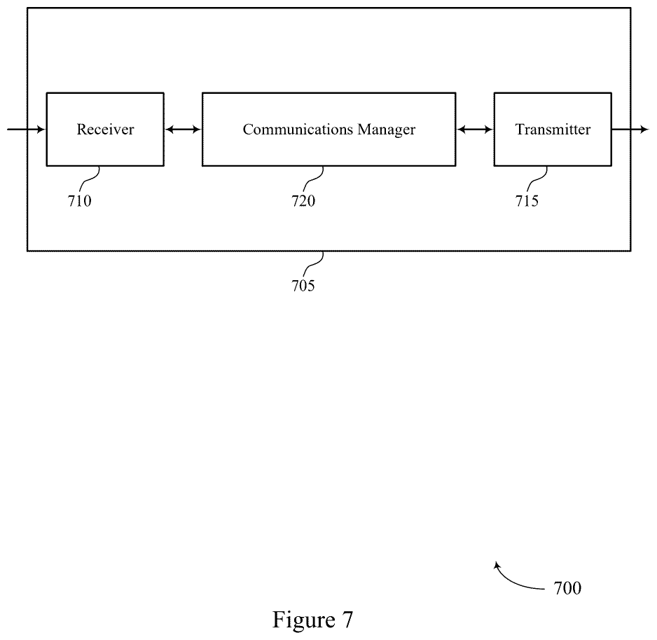

FIG. 7 shows a block diagram 700 of a device 705 that supports group-based transmission opportunity sharing. The device 705 may be an example of aspects of a STA as described herein. The device 705 may include a receiver 710, a transmitter 715, and a communications manager 720. The device 705, or one or more components of the device 705 (such as the receiver 710, the transmitter 715, the communications manager 720), may include at least one processor, which may be coupled with at least one memory, to, individually or collectively, support or enable the described techniques. Each of these components may be in communication with one another (such as via one or more buses).

The receiver 710 may provide a means for receiving information such as packets, user data, control information, or any combination thereof associated with various information channels (such as control channels, data channels, information channels related to group-based transmission opportunity sharing). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (such as control channels, data channels, information channels related to group-based transmission opportunity sharing). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of group-based transmission opportunity sharing as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (such as in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 720, the receiver 710, the transmitter 715, or various combinations or components thereof may be implemented in code (such as communications management software or firmware) executed by at least one processor (such as referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 720 may be configured to perform various operations (such as receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for outputting a first request for a transmission opportunity associated with a peer-to-peer group. The communications manager 720 is capable of, configured to, or operable to support a means for obtaining information associated with the transmission opportunity, the information including an identifier of the peer-to-peer group, where the apparatus is a member of the peer-to-peer group. The communications manager 720 is capable of, configured to, or operable to support a means for outputting a clear to send message after obtaining the transmission opportunity. The communications manager 720 is capable of, configured to, or operable to support a means for outputting, to one or more members of the peer-to-peer group, an indication of the identifier.

By including or configuring the communications manager 720 in accordance with examples as described herein, the device 705 (such as at least one processor controlling or otherwise coupled with the receiver 710, the transmitter 715, the communications manager 720, or a combination thereof) may support techniques for more efficient utilization of communication resources.

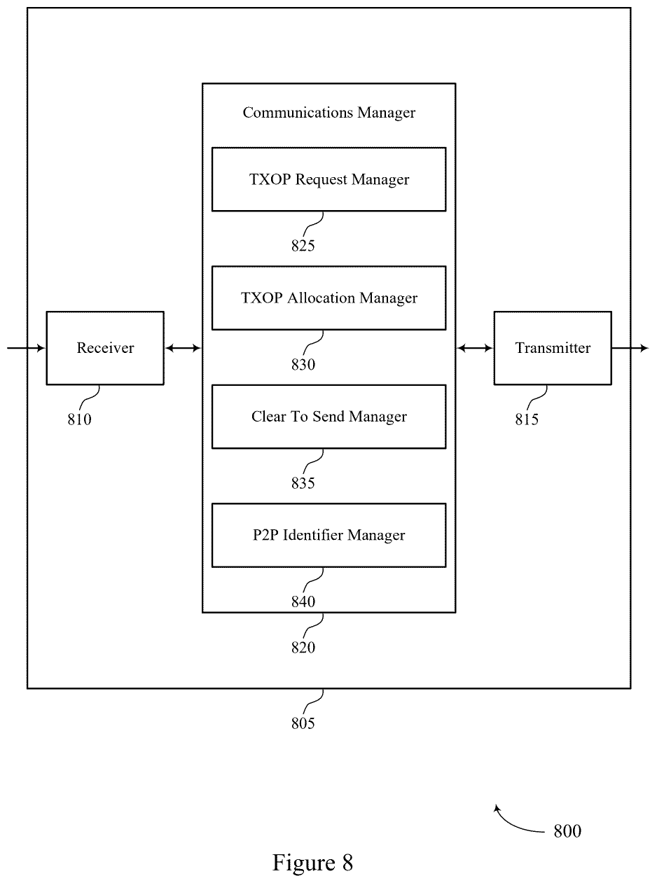

FIG. 8 shows a block diagram 800 of a device 805 that supports group-based transmission opportunity sharing. The device 805 may be an example of aspects of a device 705 or a STA 104 as described herein. The device 805 may include a receiver 810, a transmitter 815, and a communications manager 820. The device 805, or one or more components of the device 805 (such as the receiver 810, the transmitter 815, the communications manager 820), may include at least one processor, which may be coupled with at least one memory, to support the described techniques. Each of these components may be in communication with one another (such as via one or more buses).

The receiver 810 may provide a means for receiving information such as packets, user data, control information, or any combination thereof associated with various information channels (such as control channels, data channels, information channels related to group-based transmission opportunity sharing). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (such as control channels, data channels, information channels related to group-based transmission opportunity sharing). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of group-based transmission opportunity sharing as described herein. For example, the communications manager 820 may include a TXOP request manager 825, a TXOP allocation manager 830, a clear to send manager 835, a P2P identifier manager 840, or any combination thereof. The communications manager 820 may be an example of aspects of a communications manager 720 as described herein. In some examples, the communications manager 820, or various components thereof, may be configured to perform various operations (such as receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The TXOP request manager 825 is capable of, configured to, or operable to support a means for outputting a first request for a transmission opportunity associated with a peer-to-peer group. The TXOP allocation manager 830 is capable of, configured to, or operable to support a means for obtaining information associated with the transmission opportunity, the information including an identifier of the peer-to-peer group, where the apparatus is a member of the peer-to-peer group. The clear to send manager 835 is capable of, configured to, or operable to support a means for outputting a clear to send message after obtaining the transmission opportunity. The P2P identifier manager 840 is capable of, configured to, or operable to support a means for outputting, to one or more members of the peer-to-peer group, an indication of the identifier.

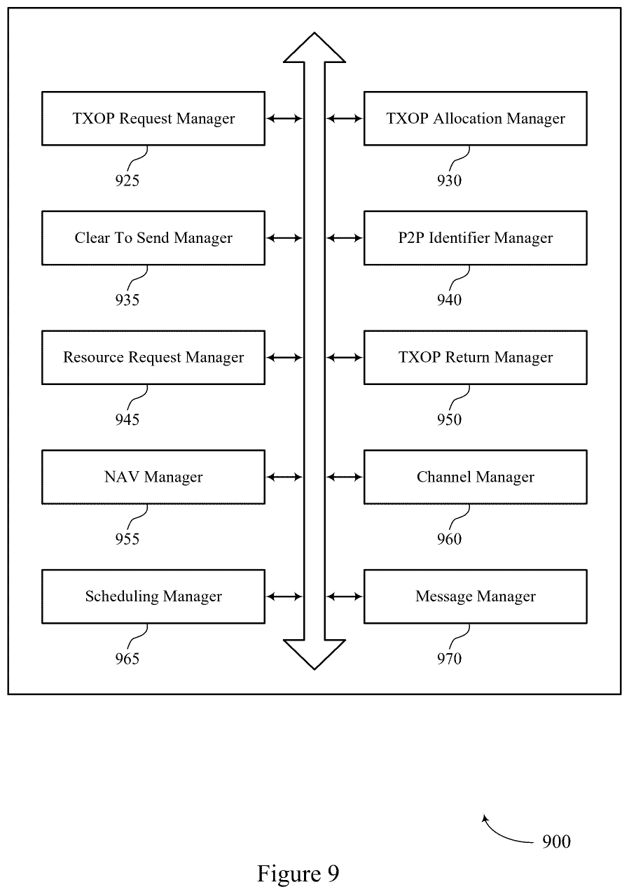

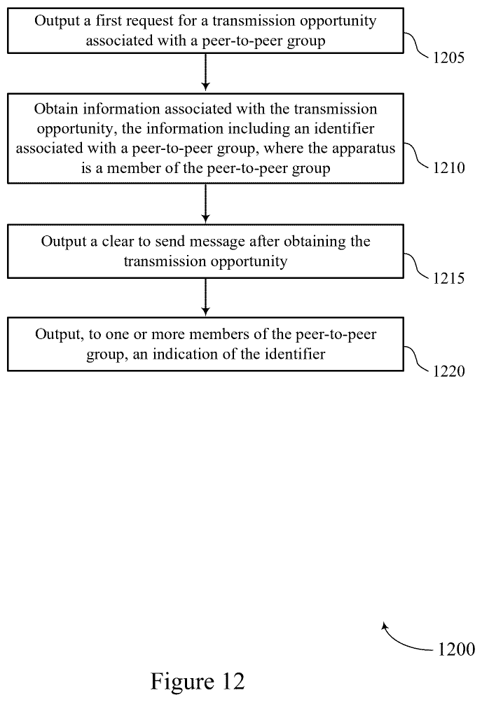

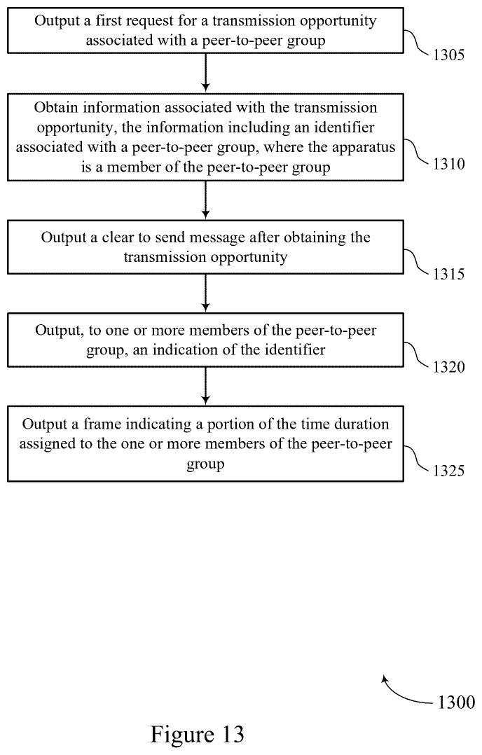

FIG. 9 shows a block diagram of an example wireless communication device 900 that supports group-based transmission opportunity sharing. In some examples, the wireless communication device 900 is configured to perform the processes 1200 and 1300 described with reference to FIGS. 12 and 13, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

Further, various components of the wireless communication device 900 may provide means for performing the methods described herein. In some examples, means for transmitting and/or receiving may include the transceivers and/or antenna(s) of the wireless communication device 900. In some examples, means for outputting or sending (such as means for outputting for transmission) and means for obtaining (such as means for obtaining after information is received from a different device) may include one or more interfaces of the wireless communication device 900 to output signals to other components or obtain signals from other components of the wireless communication device 900. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for setting, and/or means for contending, include a processing system, processor circuitry (including one or more processors), memory circuitry, and/or computer-readable media of the wireless communication device 900.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a communications manager, such as the AP 102 or the STA 104 described with reference to FIG. 1. In some other examples, the wireless communication device 900 can be a communications manager that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system. In some examples, the wireless communication device 900 further includes at least one external network interface coupled with the processing system that enables communication with a core network or backhaul network that enables the wireless communication device 900 to gain access to external networks including the Internet.

The wireless communication device 900 includes a TXOP request manager 925, a TXOP allocation manager 930, a clear to send manager 935, a P2P identifier manager 940, a resource request manager 945, a TXOP return manager 950, a NAV manager 955, a channel manager 960, a scheduling manager 965, and a message manager 970. Portions of one or more of the TXOP request manager 925, the TXOP allocation manager 930, the clear to send manager 935, the P2P identifier manager 940, the resource request manager 945, the TXOP return manager 950, the NAV manager 955, the channel manager 960, the scheduling manager 965, and the message manager 970 may be implemented at least in part in hardware or firmware. For example, one or more of the TXOP request manager 925, the TXOP allocation manager 930, the clear to send manager 935, the P2P identifier manager 940, the resource request manager 945, the TXOP return manager 950, the NAV manager 955, the channel manager 960, the scheduling manager 965, and the message manager 970 may be implemented at least in part by at least a processor or a modem. In some examples, portions of one or more of the TXOP request manager 925, the TXOP allocation manager 930, the clear to send manager 935, the P2P identifier manager 940, the resource request manager 945, the TXOP return manager 950, the NAV manager 955, the channel manager 960, the scheduling manager 965, and the message manager 970 may be implemented at least in part by a processor and software in the form of processor-executable code stored in memory.

The TXOP request manager 925 is configurable or configured to output a first request for a transmission opportunity associated with a peer-to-peer group. The TXOP allocation manager 930 is configurable or configured to obtain information associated with the transmission opportunity, the information including an identifier of the peer-to-peer group, where the apparatus is a member of the peer-to-peer group. The clear to send manager 935 is configurable or configured to output a clear to send message after obtaining the transmission opportunity. The P2P identifier manager 940 is configurable or configured to output, to one or more members of the peer-to-peer group, an indication of the identifier.

In some examples, the identifier is a value of an association identifier.

In some examples, the identifier is a value of a recipient address.

In some examples, the identifier is an indication of a TXOP sharing mode.

In some examples, the transmission opportunity is obtained as a trigger frame (e.g., a multi-user request to send TXOP sharing trigger frame) that includes the identifier associated with the peer-to-peer group.

In some examples, the resource request manager 945 is configurable or configured to obtain, prior to outputting the first request for the transmission opportunity, a resource allocation request from one or more members of the peer-to-peer group, where the resource allocation request includes a stream classification service, where the transmission opportunity is based on the stream classification service.

In some examples, the information associated with the transmission opportunity includes a time duration assigned to the peer-to-peer group.

In some examples, the information associated with the transmission opportunity includes a network allocation vector associated with the time duration.

In some examples, the NAV manager 955 is configurable or configured to set a network allocation vector associated with at least a portion of the time duration.

In some examples, the channel manager 960 is configurable or configured to contend, during the time duration and after obtaining the transmission opportunity, for a channel using random backoff.

In some examples, the random backoff is based on one or more parameters associated with traffic priority.

In some examples, the channel manager 960 is configurable or configured to contend, during the time duration and after obtaining the transmission opportunity, for a channel using prioritized enhanced distributed channel access.

In some examples, the scheduling manager 965 is configurable or configured to output a frame indicating a portion of the time duration assigned to the one or more members of the peer-to-peer group.

In some examples, at least one of the time duration is less than or equal to a transmission opportunity limit associated with an access category, the time duration is less than or equal to a duration associated with one or more data transmissions within a basic service set, or the time duration is associated with a transmission having an access category that has an associated priority higher than or equal to a priority associated with a primary access category.

In some examples, the TXOP return manager 950 is configurable or configured to output a frame indicating a return of a transmission opportunity.

In some examples, the frame indicating the return of the transmission opportunity includes a second request for a second transmission opportunity.

In some examples, the clear to send message is output by the apparatus via a first subchannel.

In some examples, the message manager 970 is configurable or configured to output a message on a second subchannel during a time duration assigned to the peer-to-peer group, where the message is different from the clear to send message.

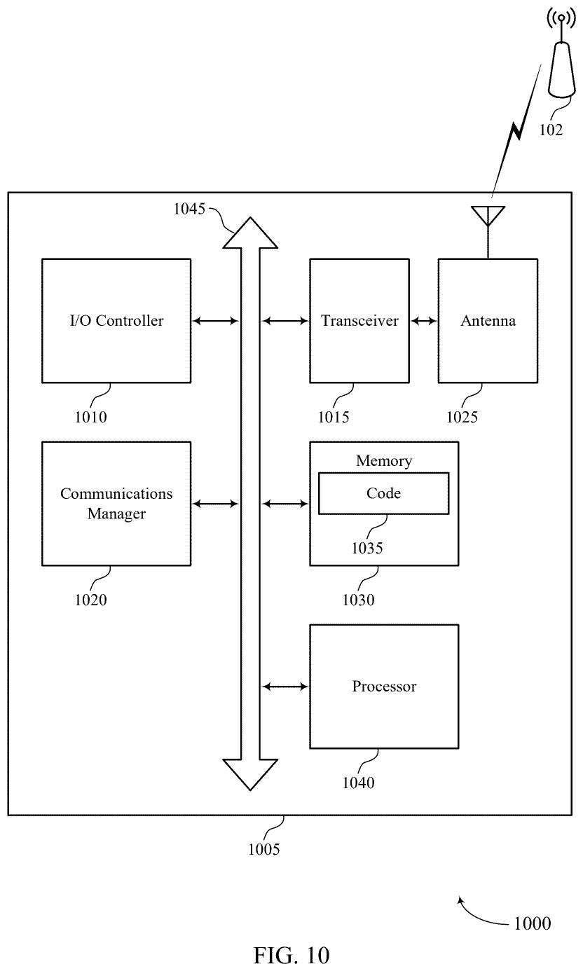

FIG. 10 shows an example of a system 1000 including a device 1005 that supports group-based transmission opportunity sharing. The device 1005 may be an example of or include components of a device 705, a device 805, or a STA as described herein. The device 1005 may include a communications manager 1020, an I/O controller, such as an I/O controller 1010, a transceiver 1015, one or more antennas 1025, at least one memory 1030, code 1035, and at least one processor 1040. Components of the device 1005 may be coupled (such as operatively, communicatively, functionally, electronically, electrically, in electronic communication) a bus 1045.

The I/O controller 1010 may manage input and output signals for the device 1005. The I/O controller 1010 also may manage peripherals not integrated into the device 1005. In some examples, the I/O controller 1010 may represent a physical connection or port to an external peripheral. In some examples, the I/O controller 1010 may utilize an operating system such as iOS®, ANDROID®, MS-DOS®, MS-WINDOWS®, OS/2®, UNIX®, LINUX®, or another known operating system. In some other cases, the I/O controller 1010 may represent or interact with a modem, a keyboard, a mouse, a touchscreen, or a similar device. In some examples, the I/O controller 1010 may be implemented as part of a processor, such as the processor 1040. In some examples, a user may interact with the device 1005 via the I/O controller 1010 or via hardware components controlled by the I/O controller 1010.

In some examples, the device 1005 may include a single antenna. However, in some other cases the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 also may include a modem to modulate the packets and provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include RAM and ROM. The memory 1030 may store computer-readable, computer-executable, or processor-executable code, such as code 1035. The code 1035 may include instructions that, when executed by the processor 1040, cause the device 1005 to perform various functions described herein. In some examples, the memory 1030 may include, among other things, a BIOS which may control basic hardware or software operation such as the interaction with peripheral components or devices.

The processor 1040 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some examples, the processor 1040 may be configured to operate a memory array using a memory controller. In some other cases, a memory controller may be integrated into the processor 1040. The processor 1040 may be configured to execute computer-readable instructions stored in a memory (such as the memory 1030) to cause the device 1005 to perform various functions (such as functions or tasks supporting group-based transmission opportunity sharing). For example, the device 1005 or a component of the device 1005 may include a processor 1040 and memory 1030 coupled to the processor 1040, the processor 1040 and memory 1030 configured to perform various functions described herein.

For example, the communications manager 1020 is capable of, configured to, or operable to support a means for outputting a first request for a transmission opportunity associated with a peer-to-peer group. The communications manager 1020 is capable of, configured to, or operable to support a means for obtaining information associated with the transmission opportunity, the information including an identifier of the peer-to-peer group, where the apparatus is a member of the peer-to-peer group. The communications manager 1020 is capable of, configured to, or operable to support a means for outputting a clear to send message after obtaining the transmission opportunity. The communications manager 1020 is capable of, configured to, or operable to support a means for outputting, to one or more members of the peer-to-peer group, an indication of the identifier.

By including or configuring the communications manager 1020 for operation in the device 1005 as described herein, may support techniques for more efficient utilization of communication resources and improved coordination between devices.

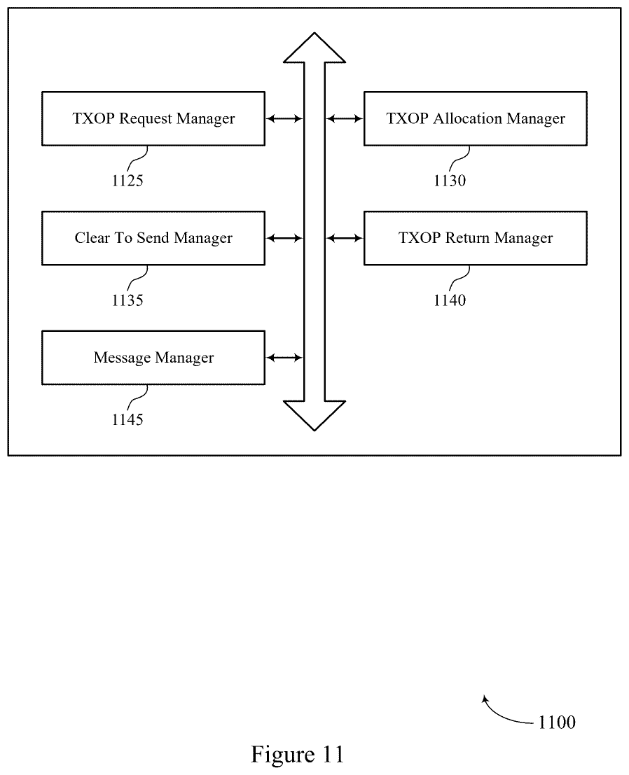

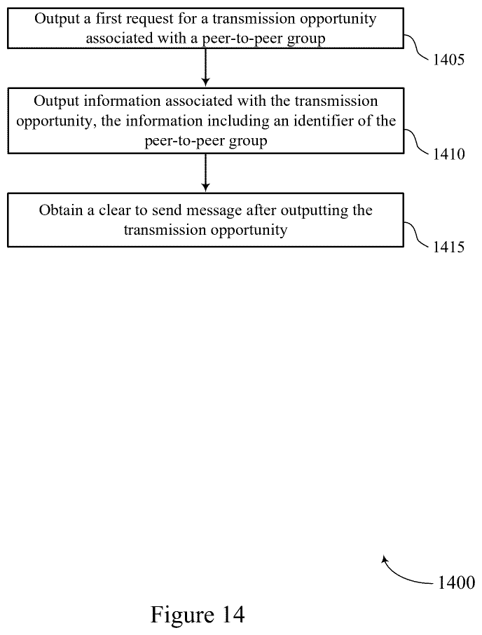

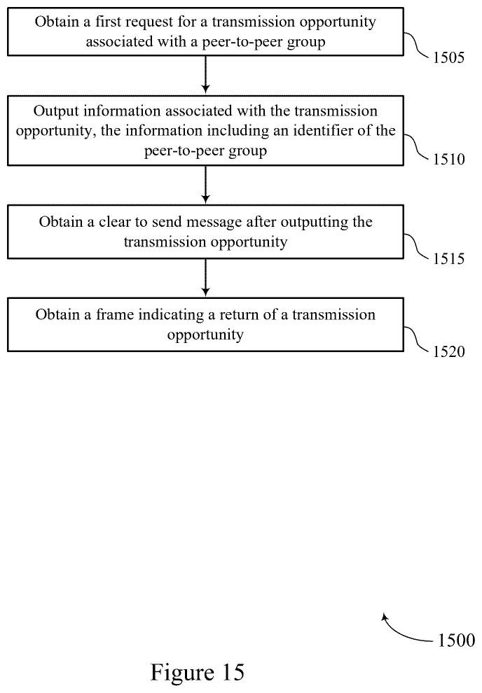

FIG. 11 shows a block diagram of an example wireless communication device 1100 that supports group-based transmission opportunity sharing. In some examples, the wireless communication device 1100 is configured to perform the processes 1400 and 1500 described with reference to FIGS. 14 and 15, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

Further, various components of the wireless communication device 1100 may provide means for performing the methods described herein. In some examples, means for transmitting and/or receiving may include the transceivers and/or antenna(s) of the wireless communication device 1100. In some examples, means for outputting or sending (such as means for outputting for transmission) and means for obtaining (such as means for obtaining after information is received from a different device) may include one or more interfaces of the wireless communication device 1100 to output signals to other components or obtain signals from other components of the wireless communication device 1100. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a TXOP request manager 1125, a TXOP allocation manager 1130, a clear to send manager 1135, a TXOP return manager 1140, and a message manager 1145. Portions of one or more of the TXOP request manager 1125, the TXOP allocation manager 1130, the clear to send manager 1135, the TXOP return manager 1140, and the message manager 1145 may be implemented at least in part in hardware or firmware. For example, one or more of the TXOP request manager 1125, the TXOP allocation manager 1130, the clear to send manager 1135, the TXOP return manager 1140, and the message manager 1145 may be implemented at least in part by at least a processor or a modem. In some examples, portions of one or more of the TXOP request manager 1125, the TXOP allocation manager 1130, the clear to send manager 1135, the TXOP return manager 1140, and the message manager 1145 may be implemented at least in part by a processor and software in the form of processor-executable code stored in memory.

The TXOP request manager 1125 is configurable or configured to obtain a first request for a transmission opportunity associated with a peer-to-peer group. The TXOP allocation manager 1130 is configurable or configured to output information associated with the transmission opportunity, the information including an identifier of the peer-to-peer group. The clear to send manager 1135 is configurable or configured to obtain a clear to send message after outputting the transmission opportunity.

In some examples, the identifier is a value of an association identifier.

In some examples, the identifier is a value of a recipient address.

In some examples, the identifier is an indication of a TXOP sharing mode.

In some examples, the transmission opportunity is output as a trigger frame (e.g., a multi-user request to send TXOP sharing trigger frame) that includes the identifier associated with the peer-to-peer group.

In some examples, the first request for the transmission opportunity includes a stream classification service. In some examples, the transmission opportunity is based on the stream classification service.

In some examples, the information associated with the transmission opportunity includes a time duration assigned to the peer-to-peer group.

In some examples, the information associated with the transmission opportunity includes a network allocation vector associated with the time duration.

In some examples, at least one of the time duration is less than or equal to a transmission opportunity limit associated with an access category, the time duration is less than or equal to a duration associated with one or more data transmissions within a basic service set, or the time duration is associated with a transmission having an access category that has an associated priority higher than or equal to a priority associated with a primary access category.

In some examples, the TXOP return manager 1140 is configurable or configured to obtain a frame indicating a return of a transmission opportunity.

In some examples, the frame indicating the return of the transmission opportunity includes a second request for a second transmission opportunity.

In some examples, the clear to send message is obtained via a first subchannel.

In some examples, the message manager 1145 is configurable or configured to obtain a message on a second subchannel during a time duration assigned to the peer-to-peer group, where the message is different from the clear to send message.

FIG. 12 shows a flowchart illustrating an example process 1200 performable by or at an apparatus that supports group-based transmission opportunity sharing. The operations of the process 1200 may be implemented by an apparatus or its components as described herein. For example, the process 1200 may be performed by a wireless communication device, such as the wireless communication device 900 described with reference to FIG. 9, operating as or within a wireless STA. In some examples, the process 1200 may be performed by a wireless STA, such as one of the STAs 104 described with reference to FIG. 1.

In some examples, in 1205, the apparatus may output a first request for a transmission opportunity associated with a peer-to-peer group. In some implementations, aspects of the operations of 1205 may be performed by a TXOP request manager 925 as described with reference to FIG. 9.

In some examples, in 1210, the apparatus may obtain information associated with the transmission opportunity, the information including an identifier of the peer-to-peer group, where the apparatus is a member of the peer-to-peer group. In some implementations, aspects of the operations of 1210 may be performed by a TXOP allocation manager 930 as described with reference to FIG. 9.

In some examples, in 1215, the apparatus may output a clear to send message after obtaining the transmission opportunity. In some implementations, aspects of the operations of 1215 may be performed by a clear to send manager 935 as described with reference to FIG. 9.

In some examples, in 1220, the apparatus may output, to one or more members of the peer-to-peer group, an indication of the identifier. In some implementations, aspects of the operations of 1220 may be performed by a P2P identifier manager 940 as described with reference to FIG. 9.

FIG. 13 shows a flowchart illustrating an example process 1300 performable by or at an apparatus that supports group-based transmission opportunity sharing. The operations of the process 1300 may be implemented by an apparatus or its components as described herein. For example, the process 1300 may be performed by a wireless communication device, such as the wireless communication device 900 described with reference to FIG. 9, operating as or within a wireless STA. In some examples, the process 1300 may be performed by a wireless STA, such as one of the STAs 104 described with reference to FIG. 1.

In some examples, in 1305, the apparatus may output a first request for a transmission opportunity associated with a peer-to-peer group. In some implementations, aspects of the operations of 1305 may be performed by a TXOP request manager 925 as described with reference to FIG. 9.

In some examples, in 1310, the apparatus may obtain information associated with the transmission opportunity, the information including an identifier of the peer-to-peer group, where the apparatus is a member of the peer-to-peer group. In some implementations, aspects of the operations of 1310 may be performed by a TXOP allocation manager 930 as described with reference to FIG. 9.

In some examples, in 1315, the apparatus may output a clear to send message after obtaining the transmission opportunity. In some implementations, aspects of the operations of 1315 may be performed by a clear to send manager 935 as described with reference to FIG. 9.

In some examples, in 1320, the apparatus may output, to one or more members of the peer-to-peer group, an indication of the identifier. In some implementations, aspects of the operations of 1320 may be performed by a P2P identifier manager 940 as described with reference to FIG. 9.

In some examples, in 1325, the apparatus may output a frame indicating a portion of the time duration assigned to the one or more members of the peer-to-peer group. In some implementations, aspects of the operations of 1325 may be performed by a scheduling manager 965 as described with reference to FIG. 9.

FIG. 14 shows a flowchart illustrating an example process 1400 performable by or at an apparatus that supports group-based transmission opportunity sharing. The operations of the process 1400 may be implemented by an apparatus or its components as described herein. For example, the process 1400 may be performed by a wireless communication device, such as the wireless communication device 1100 described with reference to FIG. 11, operating as or within a wireless AP. In some examples, the process 1400 may be performed by a wireless AP, such as one of the APs 102 described with reference to FIG. 1.

In some examples, in 1405, the apparatus may obtain a first request for a transmission opportunity associated with a peer-to-peer group. In some implementations, aspects of the operations of 1405 may be performed by a TXOP request manager 1125 as described with reference to FIG. 11.

In some examples, in 1410, the apparatus may output information associated with the transmission opportunity, the information including an identifier of the peer-to-peer group. In some implementations, aspects of the operations of 1410 may be performed by a TXOP allocation manager 1130 as described with reference to FIG. 11.

In some examples, in 1415, the apparatus may obtain a clear to send message after outputting the transmission opportunity. In some implementations, aspects of the operations of 1415 may be performed by a clear to send manager 1135 as described with reference to FIG. 11.

FIG. 15 shows a flowchart illustrating an example process 1500 performable by or at an apparatus that supports group-based transmission opportunity sharing. The operations of the process 1500 may be implemented by an apparatus or its components as described herein. For example, the process 1500 may be performed by a wireless communication device, such as the wireless communication device 1100 described with reference to FIG. 11, operating as or within a wireless AP. In some examples, the process 1500 may be performed by a wireless AP, such as one of the APs 102 described with reference to FIG. 1.

In some examples, in 1505, the apparatus may obtain a first request for a transmission opportunity associated with a peer-to-peer group. In some implementations, aspects of the operations of 1505 may be performed by a TXOP request manager 1125 as described with reference to FIG. 11.

In some examples, in 1510, the apparatus may output information associated with the transmission opportunity, the information including an identifier of the peer-to-peer group. In some implementations, aspects of the operations of 1510 may be performed by a TXOP allocation manager 1130 as described with reference to FIG. 11.

In some examples, in 1515, the apparatus may obtain a clear to send message after outputting the transmission opportunity. In some implementations, aspects of the operations of 1515 may be performed by a clear to send manager 1135 as described with reference to FIG. 11.

In some examples, in 1520, the apparatus may obtain a frame indicating a return of a transmission opportunity. In some implementations, aspects of the operations of 1520 may be performed by a TXOP return manager 1140 as described with reference to FIG. 11.

Implementation examples are described in the following numbered clauses:

The following provides an overview of aspects of the present disclosure:
Aspect 1: A method for wireless communications at a wireless node, the method comprising: outputting a first request for a transmission opportunity associated with a peer-to-peer group; obtaining information associated with the transmission opportunity, the information comprising an identifier of the peer-to-peer group, wherein the wireless node is a member of the peer-to-peer group; outputting a clear to send message after obtaining the transmission opportunity; and outputting, to one or more members of the peer-to-peer group, an indication of the identifier.
Aspect 2: The method of aspect 1, wherein the identifier is a value of an association identifier.
Aspect 3: The method of aspect 1, wherein the identifier is a value of a recipient address.
Aspect 4: The method of aspect 1, wherein the identifier is an indication of a transmission occasion sharing mode.
Aspect 5: The method of any of aspects 1-4, wherein the transmission opportunity is obtained via a frame that comprises the identifier associated with the peer-to-peer group.
Aspect 6: The method of any of aspects 1-5, further comprising: obtaining, prior to outputting the first request for the transmission opportunity, a resource allocation request from one or more members of the peer-to-peer group, wherein the resource allocation request comprises a stream classification service, wherein the transmission opportunity is based on the stream classification service.
Aspect 7: The method of any of aspects 1-6, wherein the information associated with the transmission opportunity comprises a time duration assigned to the peer-to-peer group.
Aspect 8: The method of aspect 7, wherein the information associated with the transmission opportunity comprises a network allocation vector associated with the time duration.
Aspect 9: The method of aspect 7, further comprising: setting a network allocation vector associated with at least a portion of the time duration.
Aspect 10: The method of any of aspects 7-9, further comprising: contending, during the time duration and after obtaining the transmission opportunity, for a channel using random backoff.
Aspect 11: The method of aspect 10, wherein the random backoff is based on one or more parameters associated with traffic priority.
Aspect 12: The method of any of aspects 7-9, further comprising: contending, during the time duration and after obtaining the transmission opportunity, for a channel using prioritized enhanced distributed channel access.
Aspect 13: The method of any of aspects 7-12, further comprising: outputting a frame indicating a portion of the time duration assigned to the one or more members of the peer-to-peer group.
Aspect 14: The method of any of aspects 7-13, wherein at least one of the time duration is less than or equal to a transmission opportunity limit associated with an access category, the time duration is less than or equal to a duration associated with one or more data transmissions within a basic service set, or the time duration is associated with a transmission having an access category that has an associated priority higher than or equal to a priority associated with a primary access category.
Aspect 15: The method of any of aspects 1-14, further comprising: outputting a frame indicating a return of a transmission opportunity.
Aspect 16: The method of aspect 15, wherein the frame indicating the return of the transmission opportunity comprises a second request for a second transmission opportunity.
Aspect 17: The method of any of aspects 1-16, wherein the clear to send message is output for transmission by the apparatus via a first subchannel.
Aspect 18: The method of aspect 17, further comprising: outputting for transmission a message via a second subchannel, wherein the message is output during a time duration assigned to the peer-to-peer group, wherein the message is different from the clear to send message.
Aspect 19: A method for wireless communications at a wireless node, the method comprising: obtaining a first request for a transmission opportunity associated with a peer-to-peer group; outputting information associated with the transmission opportunity, the information comprising an identifier of the peer-to-peer group; and obtaining a clear to send message after outputting the transmission opportunity.
Aspect 20: The method of aspect 19, wherein the identifier is a value of an association identifier.
Aspect 21: The method of aspect 19, wherein the identifier is a value of a recipient address.
Aspect 22: The method of aspect 19, wherein the identifier is an indication of a transmission occasion sharing mode.
Aspect 23: The method of any of aspects 19-22, wherein the transmission opportunity is output as a trigger frame that comprises the identifier associated with the peer-to-peer group.
Aspect 24: The method of any of aspects 19-23, wherein the first request for the transmission opportunity comprises a stream classification service, the transmission opportunity is based on the stream classification service.
Aspect 25: The method of any of aspects 19-24, wherein the information associated with the transmission opportunity comprises a time duration assigned to the peer-to-peer group.
Aspect 26: The method of aspect 25, wherein the information associated with the transmission opportunity comprises a network allocation vector associated with the time duration.
Aspect 27: The method of any of aspects 25-26, wherein at least one of the time duration is less than or equal to a transmission opportunity limit associated with an access category, the time duration is less than or equal to a duration associated with one or more data transmissions within a basic service set, or the time duration is associated with a transmission having an access category that has an associated priority higher than or equal to a priority associated with a primary access category.
Aspect 28: The method of any of aspects 19-27, further comprising: obtaining a frame indicating a return of a transmission opportunity.
Aspect 29: The method of aspect 28, wherein the frame indicating the return of the transmission opportunity comprises a second request for a second transmission opportunity.
Aspect 30: The method of any of aspects 19-29, wherein the clear to send message is obtained via a first subchannel.
Aspect 31: The method of aspect 30, further comprising: obtaining a message on a second subchannel during a time duration assigned to the peer-to-peer group, wherein the message is different from the clear to send message.
Aspect 32: A wireless node (e.g., a station), including one or more transceivers, and a processing system that includes processor circuitry and memory circuitry that stores code, the processing system configured to cause the wireless node to perform the method of any of aspects 1-18, wherein the one or more transceivers are configured to transmit the request, the clear to send message, and the indication, and receive the information associated with the transmission opportunity.
Aspect 33: An apparatus for wireless communication, including a processing system that includes processor circuitry and memory circuitry that stores code, the processing system configured to cause the apparatus to perform a method of any of aspects 1-18.
Aspect 34: An apparatus for wireless communication, comprising at least one means for performing a method of any of aspects 1-18.
Aspect 35: A non-transitory computer-readable medium storing code for wireless communication, the code comprising instructions executable by one or more processors to perform a method of any of aspects 1-18.
Aspect 36: A wireless node (e.g., an access point), including one or more transceivers, and a processing system that includes processor circuitry and memory circuitry that stores code, the processing system configured to cause the wireless node to perform the method of any of aspects 19-31, wherein the one or more transceivers are configured to receive the first request and the clear to send message and transmit the information associated with the transmission opportunity.
Aspect 37: An apparatus for wireless communication, comprising a processing system that includes processor circuitry and memory circuitry that stores code, the processing system configured to cause the apparatus to perform a method of any of aspects 19-31.
Aspect 38: An apparatus for wireless communication, comprising at least one means for performing a method of any of aspects 19-31.
Aspect 39: A non-transitory computer-readable medium storing code for wireless communication, the code comprising instructions executable by one or more processors to perform a method of any of aspects 19-31.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty. As used herein, a singular noun is not to be construed as being limited to a single item but may refer to one or more items.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications, comprising:
a processing system that includes processor circuitry and memory circuitry that stores code, the processing system configured to cause the apparatus to:
output a first request for a transmission opportunity associated with a peer-to-peer group;
obtain information associated with the transmission opportunity, the information comprising an identifier of the peer-to-peer group, wherein the apparatus is a member of the peer-to-peer group;
output a clear to send message after obtaining the information; and
output, to one or more members of the peer-to-peer group, an indication of the identifier.

2. The apparatus of claim 1, wherein the identifier is a value of an association identifier.

3. The apparatus of claim 1, wherein the identifier is a value of a recipient address.

4. The apparatus of claim 1, wherein the identifier is an indication of a transmission occasion sharing mode.

5. The apparatus of claim 1, wherein the information is obtained via a trigger frame.

6. The apparatus of claim 1, wherein the processing system is further configured to cause the apparatus to:
obtain, prior to outputting the first request for the transmission opportunity, a resource allocation request from one or more members of the peer-to-peer group, wherein the resource allocation request comprises a stream classification service, wherein the transmission opportunity is based on the stream classification service.

7. The apparatus of claim 1, wherein the information associated with the transmission opportunity further comprises a time duration assigned to the peer-to-peer group.

8. The apparatus of claim 7, wherein the information associated with the transmission opportunity further comprises a network allocation vector associated with the time duration.

9. The apparatus of claim 7, wherein the processing system is further configured to cause the apparatus to:
set a network allocation vector associated with at least a portion of the time duration.

10. The apparatus of claim 7, wherein the processing system is further configured to cause the apparatus to:
contend, during the time duration and after obtaining the transmission opportunity, for a channel using random backoff, wherein the random backoff is based on one or more parameters associated with traffic priority.

11. The apparatus of claim 7, wherein the processing system is further configured to cause the apparatus to:
contend, during the time duration and after obtaining the transmission opportunity, for a channel using prioritized enhanced distributed channel access.

12. The apparatus of claim 7, wherein the processing system is further configured to cause the apparatus to:
output a frame indicating a portion of the time duration assigned to the one or more members of the peer-to-peer group.

13. The apparatus of claim 7, wherein at least one of:
the time duration is less than or equal to a transmission opportunity limit associated with an access category,
the time duration is less than or equal to a duration associated with one or more data transmissions within a basic service set, or
the time duration is associated with a transmission having an access category that has an associated priority higher than or equal to a priority associated with a primary access category.

14. The apparatus of claim 1, wherein the processing system is further configured to cause the apparatus to:
output a frame indicating a return of the transmission opportunity, wherein the frame indicating the return of the transmission opportunity comprises a second request for information associated with a second transmission opportunity.

15. An apparatus for wireless communications, comprising:
a processing system that includes processor circuitry and memory circuitry that stores code, the processing system configured to cause the apparatus to:
obtain a first request for a transmission opportunity associated with a peer-to-peer group;
output information associated with the transmission opportunity, the information comprising an identifier of the peer-to-peer group; and
obtain a clear to send message after outputting the information associated with the transmission opportunity.

16. The apparatus of claim 15, wherein the identifier is at least one of:
a value of an association identifier,
a value of a recipient address, or
an indication of a transmission opportunity sharing mode.

17. The apparatus of claim 15, wherein the information is output via a trigger frame.

18. The apparatus of claim 15, wherein the first request for the transmission opportunity comprises a stream classification service, the transmission opportunity being based on the stream classification service.

19. The apparatus of claim 15, wherein the information associated with the transmission opportunity comprises a time duration assigned to the peer-to-peer group.

20. The apparatus of claim 19, wherein the information associated with the transmission opportunity comprises a network allocation vector associated with the time duration.
